(19) United States
(12) Patent Application Publication
(10) Pub. No.: US 2011/0300060 A1
(43) Pub. Date: Dec. 8, 2011

(54) OXYGEN PRODUCTION METHOD AND PLANT USING CHEMICAL LOOPING IN A FLUIDIZED BED

(76) Inventors: Florent GUILLOU, Ternay (FR); Ali Hoteit, Paris (FR)

(21) Appl. No.: 13/116,255

(22) Filed: May 26, 2011

(30) Foreign Application Priority Data
Jun. 2, 2010 (FR) 10/02328

(51) Int. Cl. C01B 13/02; B01J 8/18

(52) U.S. Cl. 423/579; 422/141

(57) ABSTRACT

The invention relates to a method and to a plant for producing high-purity oxygen, said method comprising a chemical loop wherein circulates a fluidized bed material having the capacity to release gaseous oxygen through oxygen partial pressure lowering, at a temperature ranging between 400° C. and 700° C. The oxygen thus produced can be used in applications such as oxycombustion methods, production of syngas under pressure or FCC catalyst regeneration.

### FIELD OF THE INVENTION

The field of the invention is the production of oxygen and more particularly the production of oxygen within the context of CO₂ capture.

The invention relates to an oxygen production method operating under fluidized bed conditions and using a chemical loop wherein an oxygen-carrying solid circulates.

Whereas less than twenty years ago, human impact on climate change was a mere hypothesis, scientists now maintain that the probability global warming is caused by human action is over 90%. Specialists call into question carbon dioxide (CO₂), a powerful greenhouse gas essentially due to the combustion of hydrocarbons whose proportion released to the atmosphere has doubled in the past thirty years. Worldwide awareness is real and the world political community is more sensitive to this issue than ever.

### BACKGROUND OF THE INVENTION

One of the solutions considered to reduce the amount of carbon dioxide released consists in capturing and storing the CO₂ coming from fossil fuel power plants. Three carbon dioxide capture modes are currently considered:

post-combustion, which consists in separating the CO₂ through the agency of amine wash columns; this method is the most mature but it is however a highly energy-consuming method;

pre-combustion, where the fossil fuel is first gasified to a mixture of carbon dioxide and hydrogen. After CO₂ separation, the hydrogen is used to produce electricity and/or heat. Many technological barriers still remain to be broken down in order to allow this combustion mode to be used;

oxycombustion, which consists in carrying out combustion in the presence of pure oxygen and not air. This combustion mode allows to obtain fumes essentially made up of CO₂ and water. The oxygen used results from a highly energy-consuming cryogenic distillation.

Oxycombustion units afford the advantage of producing nitrogen-free combustion fumes coming from the combustion air, since combustion is conducted with pure oxygen. This oxygen is generally produced by an air separation unit (ASU). One drawback of this combustion mode, and of ASUs in particular, is their high energy consumption and their high investment cost that increases the overall capture cost.

Document U.S. Pat. No. 6,059,858 describes a PSA (Pressure Swing Adsorption) type method for oxygen production. The adsorbent used is a solid of perovskite or CMS (Carbon-based Molecular Sieve) type operating between 300° C. and 1400° C. The pressure level in desorption ranges between 10⁻³ and 5 bar abs.

This document describes a PSA method using as the adsorbent solid a perovskite oxide in form of particles whose size ranges between 1 and 3 mm, operating at 900° C. under 10 bar in adsorption and 0.1 bar in desorption. The gas treated being air, the method produces on the one hand nitrogen with a purity above 98% and, on the other hand, oxygen with a purity above 99.9%.

However, implementation of this method requires using several distinct reactors operating alternately in adsorption or desorption phase. In order to produce a continuous oxygen stream, it is therefore necessary to use a large number of reactors (between 5 and 15) and to define precise operating sequences for each reactor. The result is a method that is relatively complex to implement, and leading to high operating and maintenance costs. Furthermore, the pressure level required for the desorption stage has to be low and it is therefore costly to obtain.

Using a chemical looping oxygen production method according to the present invention allows to overcome these drawbacks, notably as regards the energy penalty linked with the separation of oxygen from air, while involving a high potential in terms of energy efficiency and cost reduction.

Besides, the amount and the quality (in terms of purity) of the oxygen produced are such that it is advantageous to consider using it in applications such as oxycombustion methods, production of syngas under pressure or FCC catalyst regeneration.

Another advantage of the method according to the invention is that the oxygen is produced at atmospheric pressure or under low pressure, in a temperature range from 400° C. to 700° C., commonly used in units potentially arranged downstream from the oxygen production process according to the invention.

### SUMMARY OF THE INVENTION

The present invention thus relates to a method for producing high-purity oxygen, operating under fluidized bed conditions and comprising a chemical loop, wherein the following stages are carried out:

oxidizing an oxygen-carrying solid in an oxidation reaction zone (R1),

carrying under fluidized bed conditions said solid in a maximum oxidation state to an oxygen production zone (R2),

releasing the oxygen from said solid in the production zone by lowering the oxygen partial pressure at a temperature ranging between 400° C. and 700° C.,

recycling under fluidized bed conditions said solid in a decreased oxidation state to the oxidation zone,

producing an oxygen-containing gaseous effluent through a discharge line at the outlet of production zone (R2).

An oxygen-poor gaseous effluent can be injected into the oxygen production zone.

The oxygen-carrying solid can be a compound having the following formula: AₓMnO₂₋_{_{δ}}yH₂O, with 0<x≦2, 0≦y≦2 and −0.4≦δ≦0.4, where A is an alkaline or alkaline-earth ion, or a mixture of alkaline and/or alkaline-earth ions.

The oxygen-carrying solid can be selected from among: manganese oxides of OMS type comprising at least one manganese oxide of general formula AₓMn_{y}O_{z-}_{_{δ}} having a molecular sieve structure with a layout in form of channels of polygonal section, where 0<x≦2, 5≦y≦8, 10≦z≦16, −0.4≦δ≦0.4, and where A is at least one element selected from the group comprising Li, Na, K, Pb, Mg, Ca, Sr, Ba, Co, Cu, Ag, Tl, Y, or mixed iron-manganese oxides of general formula (MnₓFe₁₋ₓ)₂O₃ with x ranging between 0.10 and 0.99, and whose oxidized form has a bixbyite and/or hematite structure.

The oxygen-carrying particles can belong to group A and/or B of the Geldart classification.

The oxidation reaction zone and the oxygen production zone can be operated at a temperature ranging between 500° C. and 600° C.

The residence time of the oxygen-carrying solid can range between 10 and 600 seconds in oxidation zone (R1) and between 1 and 360 seconds in oxygen production zone (R2).

The oxygen-poor gaseous effluent injected into the oxygen production zone can be selected from among: carbon dioxide, water vapor and mixtures thereof.

The invention also relates to a plant for producing high-purity oxygen, operating under fluidized bed conditions and comprising a chemical loop, including:

an oxidation reaction zone (R1) containing an oxygen-carrying solid and comprising a supply line for an oxygen-rich effluent, a discharge line for an oxygen-poor effluent and means for carrying under fluidized bed conditions said solid in a maximum oxidation state to an oxygen production zone (R2),

the oxygen production zone comprises means for lowering the oxygen partial pressure at a temperature ranging between 400° C. and 700° C., a discharge line for a gaseous effluent rich in oxygen produced and means for carrying under fluidized bed conditions said solid in a decreased oxidation state to the oxidation zone.

In the plant, the means for lowering the oxygen partial pressure comprise a line for feeding an oxygen-poor effluent into said production zone.

The means for carrying under fluidized bed conditions said solid in a maximum oxidation state to the oxygen production zone can comprise at least one gas/solid separation means.

The method and the plant can be used for feeding an oxygen-rich effluent to oxycombustion plants, plants producing syngas under pressure or FCC catalyst regeneration plants.

What is referred to as an <<oxygen-carrying>> solid is any metallic oxide whose metal oxidation degree can vary depending on the oxygen content thereof. This variation can be used to carry oxygen between two reactive media. In an O₂-rich oxidizing medium, the degree of oxidation of the metal is at its maximum oxidation degree, i.e. the solid has a maximum oxygen content. In an O₂-poor medium and/or in a reducing medium, the previously oxidized solid will yield part of its oxygen and its oxidation state will decrease in relation to its initial maximum oxidation degree.

An oxygen-carrying solid is also defined by its oxygen carrying capacity, i.e. the amount of oxygen this carrier is likely to reversibly exchange between its most oxidized and least oxidized state. X is defined as the fraction of the total capacity of transfer of the oxygen remaining in the oxide and ΔX is defined as a variation of the fraction of the total oxygen transfer capacity.

An oxygen carrier usable for the invention is a solid that, in addition to its oxygen-carrying behaviour, is able to predominantly release spontaneously its oxygen in gas form in the reaction medium without the latter being necessarily a reducing medium.

The method according to the invention uses as the oxygen carrier a solid having an oxygen transfer capacity ranging between 0.1 and 15 mass %, preferably between 0.3 and 3 mass %.

The method according to the invention can, by way of advantageous and preferred example, use as the oxygen carrier a compound having the following formula:

AₓMnO₂₋_{_{δ}}yH₂O

with 0<x≦2, 0≦y≦2 and −0.4≦δ≦0.4, and preferably 0<x≦1, where A is an alkaline or alkaline-earth ion (elements IA or IIA of the periodic table), or a mixture of alkaline and/or alkaline-earth ions. These compounds, also referred to as <<birnessites>>, have a lamellar structure made up of sheets generated by the sequence of octahedra linked to each other through their edges. These compounds are described in French patent application Ser. No. 09/06,013 filed by the claimant.

The method according to the invention can also use manganese oxides of OMS (Octahedral Molecular Sieve) type comprising at least one manganese oxide of general formula AₓMn_{y}O_{z-}_{_{δ}} having a molecular sieve structure with a layout in form of channels of polygonal section, where 0<x≦2, 5≦y≦8, 10≦z≦16, −0.4≦δ≦0.4, and where A is at least one element selected from the group comprising Li, Na, K, Pb, Mg, Ca, Sr, Ba, Co, Cu, Ag, Tl, Y, as described in French patent application Ser. No. 09/06,018 filed by the claimant, or mixed iron-manganese oxides of general formula (MnₓFe₁₋ₓ)₂O₃ with x ranging between 0.10 and 0.99, and whose oxidized form has a bixbyite and/or hematite structure, as described in French patent application Ser. No. 09/02,095 filed by the claimant.

The oxygen carrier used in the method according to the invention can also be selected from among perovskites, brownmillerites, supraconducting materials of YBaCuO type and mixed oxides of doped cerin type, these materials being described in patent applications US-2005/0,176,588, US-2005/0,176,589 and US-2005/0,226,798.

Preferably, the oxygen-carrier particles belong to group A or B of the Geldart classification, or they consist of a mixture of particles of both groups, the Geldart classification classifying the aptitude of particles to be fluidized.

The oxidation air reactor (or reaction zone R1) allows to oxidize, in its most oxidized form and in contact with air, the oxygen-carrying solid that has been at least partly reduced so as to provide oxygen to the system.

The oxygen production reactor (or reaction zone R2) subjects the oxygen-carrying solid to an oxygen partial pressure that is maintained low through sweeping by a carrier gas or by placing under negative pressure. The oxygen contained in the solid is thus released.

The air reactor (or oxidation reaction zone) and the reduction reactor (or oxygen reduction and production reaction zone) are operated at a temperature ranging between 400° C. and 700° C., preferably between 500° C. and 600° C.

These moderate temperature ranges in relation to those mentioned in the literature, generally above 800° C., enable the use of solid flow control devices such as mechanical valves.

The residence time of the oxygen carrier in oxidation zone R1 depends on its oxidation and/or reduction state and it generally ranges between 10 and 600 seconds, preferably between 20 and 300 seconds.

The residence time of the oxygen carrier in oxygen production zone R2 generally ranges between 1 and 360 seconds, preferably between 1 and 120 seconds.

The oxygen carrier releases oxygen while being subjected to an oxygen partial pressure that is kept low, notably through sweeping by an oxygen-poor and CO₂ and/or H₂O-rich carrier gas, or by placing under negative pressure.

Directly at the outlet of oxygen production reactor R2, the purity of the oxygen produced in the carrier gas is above 90 mol. %, generally above 95 mol. % and in particular above 98 mol. %

In the oxygen production reactor, a carrier gas is injected in order to carry the oxygen produced to at least another reaction section. This carrier gas is generally selected from among carbon dioxide and water vapour, or a mixture thereof. Preferably, the carrier gas is water vapour.

The oxygen concentration in the gas stream comprising the carrier gas and the oxygen generally ranges between 5 and 20 vol. %, preferably between 7 and 15 vol. %.

The method according to the invention can be advantageously used in applications such as oxycombustion, production of syngas under pressure or FCC catalyst regeneration.

The object of the invention is also a plant allowing the method described above to be implemented.

### BRIEF DESCRIPTION OF THE FIGURES

The method according to the invention is illustrated by way of non-limitative example by the accompanying figures, wherein:

FIG. 1 shows a first embodiment of the method according to the invention, and

FIG. 2 shows a second embodiment.

### DETAILED DESCRIPTION

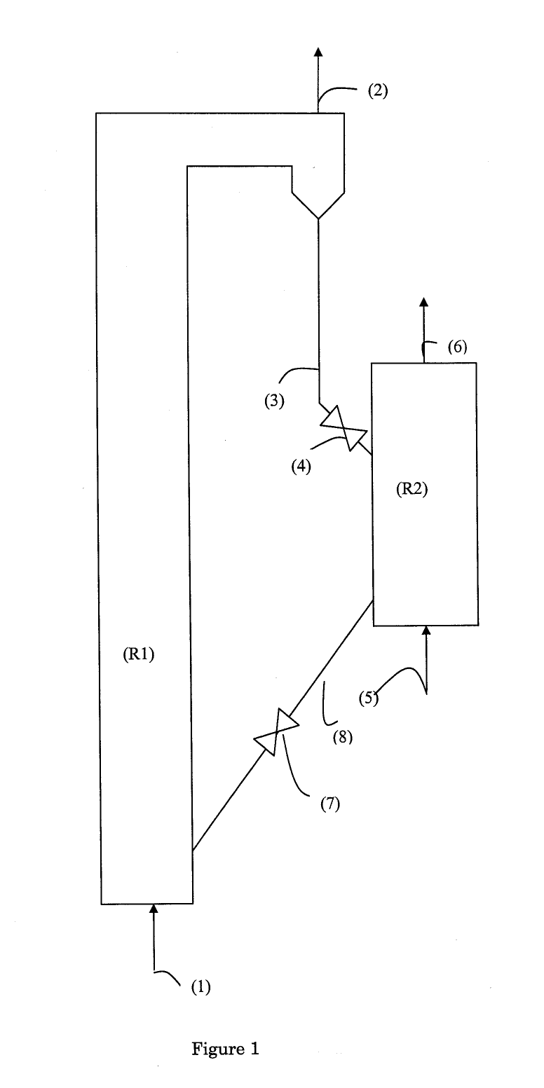

According to FIG. 1, the plant comprises at least:

an oxidation reaction zone R1 using under fluidized bed conditions an oxygen-carrying solid coming from a reaction zone R2 through a line (8) after passage through a mechanical valve (7). The oxygen-carrying solid is contacted in reaction zone R1 with air fed through a line (1) so as to be oxidized to the maximum. The oxygen-poor gaseous effluent is extracted from reaction zone R1 through a line (2) and the oxygen-carrying solid particles are discharged through a line (3),

a reaction zone R2, also operating under fluidized bed conditions, wherein oxygen is produced from the oxygen-carrying solid particles supplied through line (3) after passage through a mechanical valve (4) and in the presence of an oxygen-poor and water vapour-rich effluent fed to reaction zone R2 through a line (5). The gaseous effluent containing oxygen, mixed with water vapour and/or carbon dioxide, is extracted from reaction zone R2 through a line (6). The metallic oxide particles in decreased oxidation state are discharged through a line (8) to oxidation reaction zone R1.

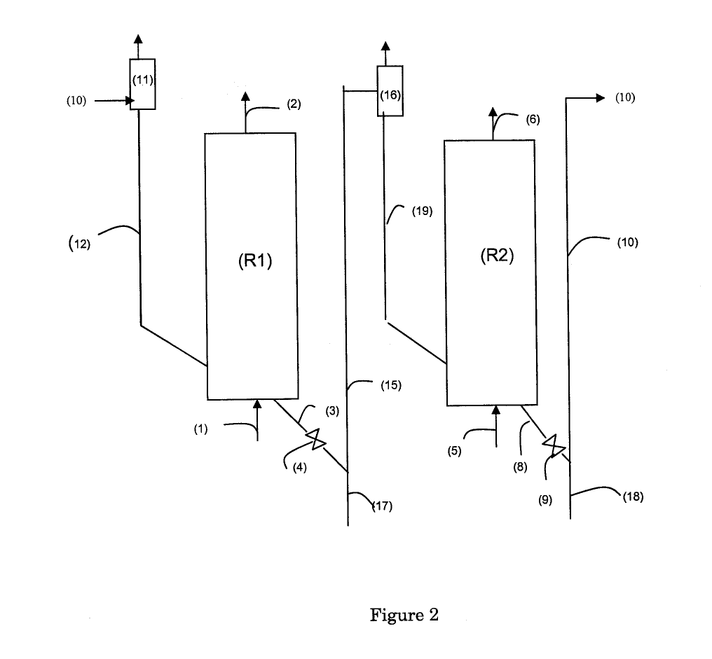

FIG. 2 describes a second embodiment of the invention wherein the oxygen-carrying solid (metallic oxide) is contacted with air supplied through a line (1) in order to be oxidized in zone R1. Reaction zone R1 can comprise a simple fluidized-bed reactor equipped with a box for delivering gas over the section, or a fluidized bed and means (not shown) for dedusting the oxygen-poor gaseous effluent extracted from reaction zone R1 through a line (2), or a combination of fluidized beds, or circulating fluidized beds with internal or external particle recycle. In reaction zone R1, at least part of the zone of contact between the air and the metallic oxide consists of a dense fluidized phase. The metallic oxide particles are withdrawn from reaction zone R1 through a line (3) and sent through a mechanical valve (4) prior to being fed into a pneumatic conveying line (15) supplied with conveying gas through a line (17).

At the outlet of pneumatic conveying line (15), at least one separation means (16), a cyclone for example, allows to separate the conveying gas from the particles that are conveyed through a line (19) to a second reaction zone R2 operating under fluidized bed conditions wherein oxygen production occurs upon contact with oxide particles and in the presence of an oxygen-poor and water vapour-rich effluent sent to the second reaction zone through a line (5). The second reaction zone can comprise a simple fluidized-bed reactor equipped with a box for delivering gas over the section, or a fluidized bed and means (not shown) for dedusting the gaseous effluent extracted from reaction zone R2 through a line (6)—said effluent containing oxygen mixed with water vapour and/or carbon dioxide—, or a combination of fluidized beds, or circulating fluidized beds with internal or external particle recycle. In production zone R2, at least part of the zone of contact between the air and the metallic oxide consists of a dense fluidized phase. The metallic oxide particles are withdrawn from second reaction zone R2 through a line (8) and sent through a mechanical valve (9) prior to being fed into a mechanical conveying line (10) supplied with conveying gas through a line (18). In the chemical loop thus formed, at the outlet of mechanical conveying line (10), a separation means (11), a cyclone for example, allows to separate the conveying gas from the particles carried through a line (12) to first reaction zone R1 where oxidation takes place.

According to FIG. 2, a chemical looping method comprising two reaction zones is described, but it is possible according to the invention to consider a sequence of several pairs of reaction zones arranged in series and relooped.

### Example

A flow rate of 100 t/h oxygen intended to feed an FCC catalyst regeneration unit is to be produced.

The oxygen-carrying solid used in the chemical loop has formula (Mn_{0.4}Fe_{0.6})₂O₃.

The reaction heat taken into account is 66.3 kJ per mole of O₂ produced.

In the case of the oxygen carrier selected, the mass fraction of oxygen spontaneously releasable in the reaction medium is 1.5%, which involves, in order to have the required amount of oxygen, setting the solid circulation rate at 1851 kg/s at the oxidation air reactor outlet. The operating temperature of the loop at the oxygen production reactor outlet is 500° C.

The oxygen production reactor is swept with 415 m³/s vapour at 562° C.

The fumes enriched in 10 vol. % oxygen are extracted from the reactor at a temperature of 500° C.

At the level of the air reactor, the solid stream at 500° C. is contacted with 119 kg/s air at 425° C. After the reverse reaction to the O₂ production reaction, an O₂-depleted air stream at 600° C. and a regenerated solid flow of 1851 kg/s at 600° C. are thus obtained.

The chemical combustion loop is thermally integrated so that the heat recovery is optimized.

Thus, the water stream required for carrier gas formation is heated and vaporized by the oxygen-enriched stream (184 kg/s at 500° C.) so as to bring the vapour to 495° C.

The oxygen-depleted air stream allows to heat the vapour up to 562° C.

The residual heat of the oxygen enriched and depleted streams allows to heat the 119 kg/s air to 311° C. The required makeup for reaching the temperature of 425° C. is provided by an outside heating device for a power of 15 MWth.

An oxygen-depleted air stream at 34° C. is thus obtained.

As for the oxygen-enriched stream, after heating and vaporizing the water, its temperature drops to 32° C. At this temperature, the liquid water contained in the stream is withdrawn and the oxygen composition is then 95%, prior to cooling the oxygen-enriched stream upon contact with the water stream at 15° C., which allows to reach a temperature of 17° C. and to further condense a fraction of the water contained in the stream so as to reach 96% oxygen purity. The only compound present in addition to the oxygen is H₂O, No other non-condensable gas than oxygen remains.

As regards utilities consumption, it is limited to the compression of the air at the air reactor inlet, i.e. an estimated electric power consumption of 4 MWe.

This electric power consumption is equivalent to 25 MWth with an electricity production efficiency of 40%.

By comparison, the efficiency loss linked with the use of a cryogenic ASU is of the order of 17.3 Mwe for a production of 100 t/h oxygen. This leads, in equivalent thermal power, to a value of 43 MWth with the same electricity production efficiency, i.e. an energy penalty approximately 170% higher than the consumption of an oxygen production chemical loop.

Moreover, the composition of the oxygen at the outlet of a cryogenic ASU is 95% oxygen, i.e. a purity equivalent to that obtained with a chemical loop. On the other hand, the residual gases are uncondensables, such as argon and nitrogen. To reach a higher purity, it is necessary to provide much supplementary energy whereas, in the case of the chemical loop, the purity of the oxygen can be increased simply by condensation of the residual water.

Thus, oxygen production through chemical looping affords a substantial advantage both as regards energy and quality as well, i.e. oxygen purity.

1) A method for producing high-purity oxygen, operating under fluidized bed conditions and comprising a chemical loop, wherein the following stages are carried out:
oxidizing an oxygen-carrying solid in an oxidation reaction zone (R1),
carrying under fluidized bed conditions said solid in a maximum oxidation state to an oxygen production zone (R2),
releasing the oxygen from said solid in the production zone by lowering the oxygen partial pressure at a temperature ranging between 400° C. and 700° C.,
recycling under fluidized bed conditions said solid in a decreased oxidation state to the oxidation zone,
producing an oxygen-containing gaseous effluent through a discharge line at the outlet of production zone (R2),
wherein the oxygen-carrying solid is a compound having the following formula: AₓMnO₂₋_{_{δ}}yH₂O, with 0<x≦2, 0≦y≦2 and −0.4≦δ≦0.4, where A is an alkaline or alkaline-earth ion, or a mixture of alkaline and/or alkaline-earth ions, or a compound selected from among: manganese oxides of OMS type comprising at least one manganese oxide of general formula AₓMn_{y}O_{z-}_{_{δ}} having a molecular sieve structure with a layout in form of channels of polygonal section, where 0<x≦2, 5≦y≦8, 10≦z≦16, −0.40≦δ≦0.4, and where A is at least one element selected from the group comprising U, Na, K, Pb, Mg, Ca, Sr, Ba, Co, Cu, Ag, Tl, Y, or mixed iron-manganese oxides of general formula (MnₓFe₁₋ₓ)₂O₃ with x ranging between 0.10 and 0.99, and whose oxidized form has a bixbyite and/or hematite structure.

2) A method as claimed in claim 1, wherein an oxygen-poor gaseous effluent is injected into the oxygen production zone.

3) A method as claimed in any one of the previous claims, wherein the oxygen-carrying particles belong to group A and/or B of the Geldart classification.

4) A method as claimed in any one of the previous claims, wherein the oxidation reaction zone and the oxygen production zone are operated at a temperature ranging between 500° C. and 600° C.

5) A method as claimed in any one of the previous claims, wherein the residence time of the oxygen-carrying solid ranges between 10 and 600 seconds in oxidation zone (R1) and between 1 and 360 seconds in oxygen production zone (R2).

6) A method as claimed in any one of claims 2 to 5, wherein said oxygen-poor gaseous effluent injected into the oxygen production zone is selected from among: carbon dioxide, water vapour and mixtures thereof.

7) A plant for producing high-purity oxygen, operating under fluidized bed conditions and comprising a chemical loop, including:
an oxidation reaction zone (R1) containing an oxygen-carrying solid and comprising a supply line for an oxygen-rich effluent, a discharge line for an oxygen-poor gaseous effluent and means for carrying under fluidized bed conditions said solid in a maximum oxidation state to an oxygen production zone (R2),
the oxygen production zone comprises means for lowering the oxygen partial pressure at a temperature ranging between 400° C. and 700° C., said partial pressure lowering means comprising a delivery line for feeding an oxygen-poor effluent into said production zone, a discharge line for a gaseous effluent rich in oxygen produced and means for carrying under fluidized bed conditions said solid in a decreased oxidation state to the oxidation zone.

8) A plant as claimed in claim 7, wherein the means for carrying under fluidized bed conditions said solid in a maximum oxidation state to the oxygen production zone comprise at least one gas/solid separation means (16).

9) Use of the method as claimed in any one of claims 1 to 6 and of the plant as claimed in any one of claims 7 to 8 for feeding an oxygen-rich effluent to oxycombustion plants, plants producing syngas under pressure or FCC catalyst regeneration plants.
